(19) United States
(12) Patent Application Publication
(10) Pub. No.: US 2013/0047145 A1
(43) Pub. Date: Feb. 21, 2013

(54) MATCH ANALYSIS FOR ENCODING OPTIMIZED UPDATE PACKAGES

(71) Applicant: Quan-Jie Cui, Beijing (CN)

(72) Inventor: Quan-Jie Cui, Beijing (CN)

(21) Appl. No.: 13/640,751

(22) PCT Filed: Apr. 23, 2010
(86) PCT No.: PCT/CN10/00561

§ 371 Date: Oct. 12, 2012

(30) Foreign Application Priority Data
Aug. 29, 2006 (DE) 102006010395.9

(51) Int. Cl. G06F 9/44

(52) U.S. Cl. 717/168

(57) ABSTRACT

Various embodiments relate to optimization of an update package by performing analysis of matches. In some embodiments, a mechanism is provided to receive an updated executable file and a previous executable file. In addition, a mechanism is provided to determine a plurality of matches, each match representing a set of commands used to generate a portion of the updated executable file using the previous executable file. Furthermore, a mechanism is provided to analyze the matches and, based on the analysis, encode an optimized update package.

### BACKGROUND

Computer programs, which may be implemented in the form of software or firmware executable on a computing device, are susceptible to errors or faults that cause incorrect or unexpected results during execution. Such errors or faults are more commonly known as “bugs.” In situations where a bug will affect performance, render a product unstable, or affect the usability of the product, the developer may find it advisable to release a software or firmware update to correct the problem. A developer may also release an update to add additional features or improve performance of the product. In general, the update includes a number of instructions used to transform the existing version stored on the user device to the updated version.

In a typical implementation, a developer transmits the software or firmware update package to the user over a wired or wireless network. For example, when the user device is a mobile phone, portable reading device, or other mobile device, the user may receive the update over a cellular or other wireless network. Similarly, when the user device is a desktop or laptop computer, the user may receive the update over a wired network.

Regardless of the transmission medium used to transmit the update to the user, it is desirable to minimize the size of the update package. By making the update package as small as possible, the developer may reduce the amount of time required to transmit the update to the user and to install the update on the user's device, thereby resulting in an increase in the user's satisfaction. Similarly, minimizing the size of the update package reduces bandwidth usage, thereby reducing costs to both the user and the network provider. Existing solutions employ a number of techniques in an attempt to generate an update package of minimal size, but, ultimately, could be improved to further decrease download time, bandwidth usage, and installation time.

### BRIEF DESCRIPTION OF THE DRAWINGS

In the accompanying drawings, like numerals refer to like components or blocks. The following detailed description references the drawings, wherein:

FIG. 1 is a block diagram of an example computing device for generation of an optimized update package;

FIG. 2 is a block diagram of an example system for generation and distribution of an optimized update package to a client computing device;

FIG. 3 is a flowchart of an example method for analyzing matches to generate and distribute an optimized update package;

FIG. 4 is a flowchart of an example method for processing a plurality of sections of an updated executable file to generate and distribute an optimized update package;

FIGS. 5A, 5B, and 5C are flowcharts of an example method for performing optimization of each match candidate for inclusion in an optimized update package;

FIG. 6A is a block diagram of an example of a previous executable file and an updated executable file; and

FIG. 6B is a block diagram of an example of a matching without mismatches, a matching with mismatches, and an optimized matching for generation of an optimized update package for the executable files of FIG. 6A.

### DETAILED DESCRIPTION

As detailed above, existing solutions for generating an update package could be improved to further decrease the size of the resulting update package. Thus, as described below, example embodiments relate to analysis of the matches used to output an update package that contains instructions for generating the updated executable file. By analyzing the matches to select a matching technique that minimizes costs, example embodiments allow for the generation of an optimized update package of a minimal size.

In particular, in some embodiments, a plurality of matches may be determined, with each match representing a set of commands used to generate a portion of an updated executable file using a previous executable file. A matching with mismatches technique may then be compared with a matching without mismatches technique for each of the matches. Based on the comparison, an optimal technique of the two may be selected for each of the matches and, using the selected technique for each match, an optimized update package may be encoded. In this manner, an optimized update package of a minimized size may be generated to update the previous executable file to a new version. Additional embodiments and applications of such embodiments will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that contains or stores executable instructions or other data (e.g., a hard disk drive, flash memory, etc.).

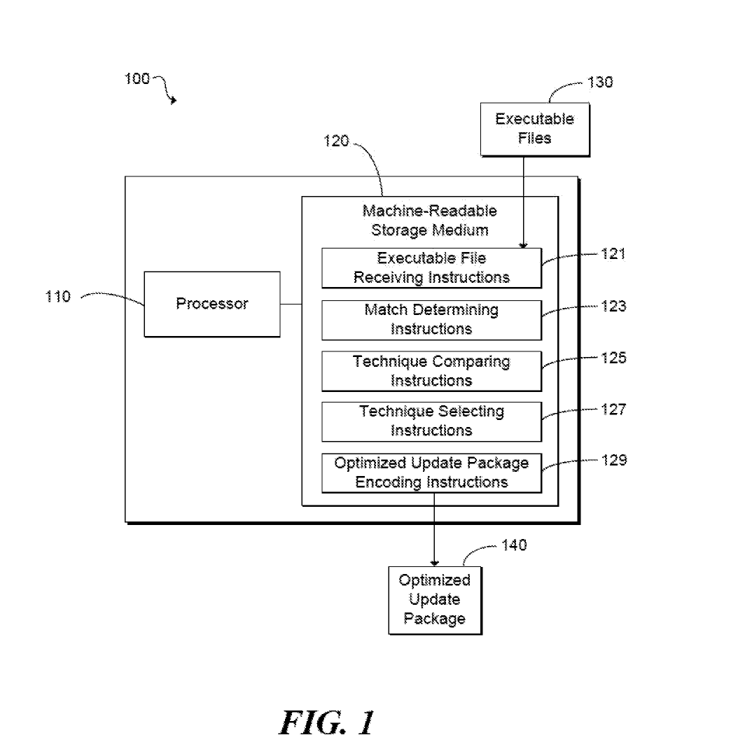

Referring now to the drawings, FIG. 1 is a block diagram of an example computing device 100 for generation of an optimized update package 140. Computing device 100 may be, for example, a desktop computer, a laptop computer, a server, a workstation, or the like. In the embodiment of FIG. 1, computing device 100 includes a processor 110 and a machine-readable storage medium 120.

Processor 110 may be a central processing unit (CPU), a semiconductor-based microprocessor, or any other hardware device suitable for retrieval and execution of instructions stored in machine-readable storage medium 120. Machine-readable storage medium 120 may be encoded with executable instructions for receiving an executable file, determining matches, comparing and selecting matching techniques, and encoding an optimized update package. Thus, processor 110 may fetch, decode, and execute the instructions 121, 123, 125, 127, 129 encoded on machine-readable storage medium 120 to implement the functionality described in detail below.

In particular, machine-readable storage medium 120 may include executable file receiving instructions 121, which may receive two executable files 130. More specifically, receiving instructions 121 may receive a previous version and an updated version of the executable file, both of which may include a series of instructions executable by a processor of a client computing device. The previous version of the executable file may be, for example, an executable that is currently distributed to a client base, while the updated version may be a new version that has yet to be distributed. Thus, a developer or other entity may provide executable files 130 as input in order to obtain an optimized update package 140 that includes instructions for generating the updated executable file using the previous version. Such a process avoids the need for the client base to obtain the entire updated executable, as the update package 140 may reuse duplicated data from the previous version.

Upon receipt by receiving instructions 121, executable files 130 may be provided to match determining instructions 123. Match determining instructions 123 may compare the data contained in the previous executable file with the data included in the updated executable file to determine which data is duplicated in the updated version and which data is new or has been moved to a new address. In particular, match determining instructions 123 may determine a plurality of matches, with each match representing a set of commands used to generate a portion of the updated executable file using the previous executable file. In particular, to represent the set of commands, each match may either contain the commands themselves or otherwise identify each command for use in encoding the optimized update package (e.g., using a data type that corresponds to the particular command).

In some embodiments, match determining instructions 123 may initially determine the matches using a matching with mismatches technique. In particular, in such embodiments, match determining instructions 123 may divide the previous executable file into a series of blocks (e.g., 8 byte blocks) and similarly divide the updated executable file into a series of blocks. After dividing each executable into blocks, match determining instructions 123 may start with a first block in the updated executable file and attempt to identify a section in the previous executable file that matches that block. Upon encountering a matching block in the previous executable file, match determining instructions 123 may continue to traverse the previous executable file in an attempt to find a group of matching blocks as long as possible. Thus, a particular match may be a mapping to a group of bytes in the previous executable file that match a corresponding group of bytes in the updated executable file.

In implementing the matching with mismatches technique, match determining instructions 123 may tolerate a mismatch of up to a predetermined number of bytes, known as the mismatch length (e.g., 4 bytes, 8 bytes, etc.). Thus, when determining a particular match using the matching with mismatches technique, instructions 123 may terminate a particular match only upon reaching a non-matching portion of the previous executable file that has a length greater than the mismatch length. For the non-matching blocks with a length less than the mismatch length, matching determining instructions 123 may encode a command that includes the non-matching data to be included in the updated executable file.

Thus, in some embodiments, match determining instructions 123 may generate a set of commands for generating the updated executable file using the previous executable file or, as one alternative, generate data types representing those commands. Match determining instructions 123 may generate a series of matches, each of which may include zero or more mismatches. For example, a particular match may include a “copy” command and zero or more “set pointer” commands. A copy command may mark the boundaries of the match and may be of the following form:
COPY <from> <length>,
   where <from> indicates an offset in the previous executable file and <length> indicates a length of the match. Thus, a copy command utilizes an exact copy of the data included in the previous executable file to generate a corresponding set of data in the updated executable file. In order to encode the mismatches within the boundaries defined by a given copy command, a particular match may include zero or more “set pointer” commands, which may be of the following form:
SET PTR <length> <from> <data>,
   where <length> is a number of bytes in the mismatch (which will be less than or equal to the mismatch length), <from> is an offset from a location of the start of the match, and <data> encodes the non-matching portion of data.

In some embodiments, the length parameter may be encoded into the SET PTR command, such that the length parameter may be omitted. For example, a different one byte opcode may be utilized for each possible mismatch length, such that the length parameter is incorporated into the one byte used for the command. In such instances, each set pointer command may be of the form:
SET PTR <from> <data>,
   where the length is encoded into the command, <from> is the offset from the location of the start of the match, and <data> encodes the non-matching portion of data.

In some embodiments, match determining instructions 123 may generate commands based on an implementation of a set pointer cache, which may store blocks of data that were previously used to encode another mismatch. Such an implementation allows a particular set pointer command to rely on a cache of non-matching data portions. As a result, in the event of a cache hit for a particular mismatch (i.e., when the same data has already been included in another mismatch), the non-matching data need not be encoded as a <data> parameter in a SET PTR CACHE command.

In addition to the matches, an update package may include a number of non-matching portions, which may be encoded using a “set” command of the following form:
SET DATA <length> <data>,
   where <length> indicates a length of the non-matching portion (which will be greater than the mismatch length) and <data> encodes the non-matching portion of data. As detailed below, in some embodiments, the match optimization procedure may be based on analysis of the matches, rather than the non-matching portions. It should be noted that the matching without mismatches technique (which is another encoding technique) may encode the entire updated executable file using only COPY and SET DATA commands. The comparison of the matching with mismatches and matching without mismatches techniques is described in detail below.

In some embodiments, the matching with mismatches described above may be determined using the technique described in U.S. Patent Application Publication No. 2006/0107260, “Efficient Generator of Update Packages for Mobile Devices,” to Giovanni Motta. Other suitable sets of commands and methods for determining the matches for generating the update package will be apparent to those of skill in the art.

After determining a set of matches that map the previous version of the executable file to the updated version, the matches may be provided to technique comparing instructions 125. Technique comparing instructions 125 may operate based on the assumption that, in some cases, a matching with mismatches may require more bytes to encode than a corresponding matching without mismatches. For example, when a particular matching with mismatches includes a large number of mismatches of a very small length, it may be more efficient to simply combine these mismatches into a single set data command, rather than encoding them as a series of set pointer commands. Thus, as described below, technique comparing instructions 125 may compare the matching with mismatches and matching without mismatches for each match and pass these comparisons to technique selecting instructions 127 for selection of the technique that will minimize the cost of encoding the match.

More specifically, in response to receipt of the determined matches, technique comparing instructions 125 may determine, for each match, a cost of encoding the match using the matching with mismatches technique as compared to the cost of using the matching without mismatches technique. In particular, in some embodiments, technique comparing instructions 125 may be based on the observation that, as compared to a set command, each set pointer command used in a matching with mismatches introduces a cost decrement or savings for some portions of the command and a cost increment for other portions. A cost decrement for a particular set pointer command may be the number of adjacent bytes that are matching. In particular, as compared to a set data command, in which all bytes are encoded (including matching bytes), a set pointer command eliminates the need to encode the matching bytes. In embodiments in which a set pointer cache is utilized, the cost decrement may also include the cost of the <data> parameter for a cache hit, as the data need not be included in the command when it is already encoded in the cache. In contrast, a cost increment for a set pointer command may be the additional bytes required to encode the command, which may include the cost of the command and the cost of the <from> parameter.

Technique selecting instructions 127 may receive the results of the technique comparison for each match and, in response, may select an optimal technique that provides a minimal cost for each match analyzed by technique comparing instructions 125. In this manner, technique selecting instructions 127 may determine a combination of sections encoded with matching with mismatches and matching without mismatches that minimizes the total cost of the update package.

For example, in implementations in which technique comparing instructions 125 determine a cost decrement and increment for a number of set pointer command locations in each match, technique selecting instructions 127 may select an optimal location in the match that provides a largest difference between the decrement and increment. As described below, encoding instructions 129 may then utilize this location to combine the two techniques in a manner that optimizes the cost of the update package. In some embodiments, such a location may be determined by dividing the matches into subsections, known as “check regions” and “check units.” Such embodiments are described in further detail below.

Finally, optimized update package encoding instructions 129 may generate the update package using the optimal combination of techniques determined by technique selecting instructions 127. In particular, for each match, optimized update package encoding instructions 129 may generate instructions that include the commands for the selected technique. Thus, when it is determined that the matching with mismatches technique should be used up to an optimal location in a given match, encoding instructions 129 may generate a copy command to encode the boundaries of the match and zero or more set pointer commands to encode any mismatches contained therein.

When the optimal location is prior to the end of the match, encoding instructions 129 may generate a set command to encode the remaining non-matching portions of the match. In contrast, when it is determined that the matching without mismatches technique is the optimal technique for a particular match, encoding instructions 129 may utilize a copy command up to the first mismatch and utilize a set command for the remaining portion of the match. By proceeding in this manner for each match, encoding instructions 129 may generate an optimized update package 140, which may include instructions for generating the updated executable file using the previous executable file.

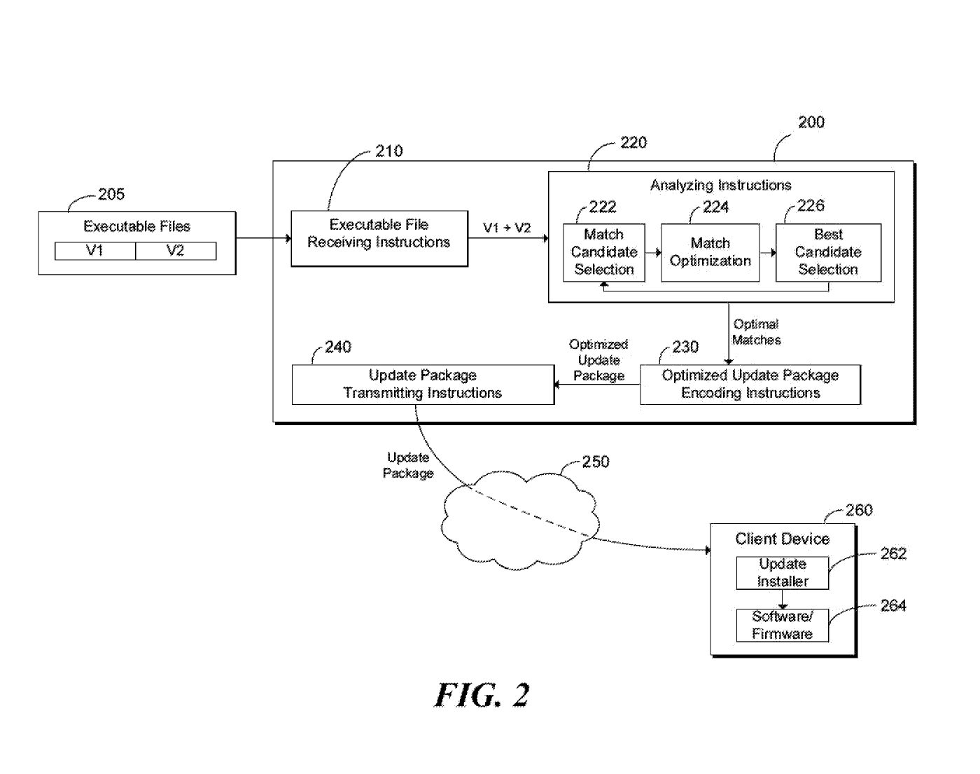

FIG. 2 is a block diagram of an example system for generation of an optimized update package and distribution of the package to a client computing device 260. As illustrated, the system may include a computing device 200, a network 250, and a client device 260.

As with computing device 100 of FIG. 1, computing device 200 may be, for example, a desktop computer, a laptop computer, a server, a workstation, or the like. Computing device 200 may include a processor (not shown) for executing instructions 210, 220, 230, 240. Instructions 210, 220, 230, 240 may be encoded on a machine-readable storage medium (not shown) for retrieval and execution by the processor.

Executable file receiving instructions 210 may be similar to executable file receiving instructions 121 of FIG. 1. In particular, executable file receiving instructions 210 may receive two executable files 205, V1 and V2, corresponding to a previous version of an executable file and an updated version of the executable file, respectively. Executable file receiving instructions 210 may provide the two versions, V1 and V2, to analyzing instructions 220 for processing.

Analyzing instructions 220 may receive the two versions, V1 and V2, determine a number of match candidates, optimize each match, then select a best candidate for each match. Instructions for implementing each of these steps of the process are described in turn below.

First, match candidate selection instructions 222 may compare the data contained in V1 with the data included in V2 to determine which data is duplicated from V1, which data has moved, and which data is new. In particular, match candidate selection instructions 222 may use V1 as a match source and, to prepare for the matching, calculate a cyclic redundancy check (CRC) for a number of blocks of V1. Then, for each block of data in V2, candidate selection instructions 222 may calculate a CRC, then search for a matching CRC in V1. When a matching CRC is located, instructions 222 may continue the matching process with adjacent blocks in V1 and V2 to obtain a match as long as possible.

As described in detail above, this process may be executed using a predetermined mismatch length, such that a particular matching ends only when reaching a mismatch greater than the mismatch length. Match candidate selection instructions 222 may repeat this process multiple times for each block in V2 until all possible matches are located. Each of these possible matches is known as a match candidate. As described in detail above, each match candidate may include a copy command and zero or more set pointer commands.

After determining all candidates for a particular block in V2, match optimization instructions 224 may analyze each candidate to determine an optimal matching. In particular, optimization instructions 224 may determine an optimal number of set pointer commands that minimizes a cost of encoding the match candidate. The number of set pointer commands included in the optimized match will therefore be between zero and the number of set pointer commands originally included in the match. Such an optimization process may be similar to the process described in detail above in connection with technique comparing instructions 125 and technique selecting instructions 127.

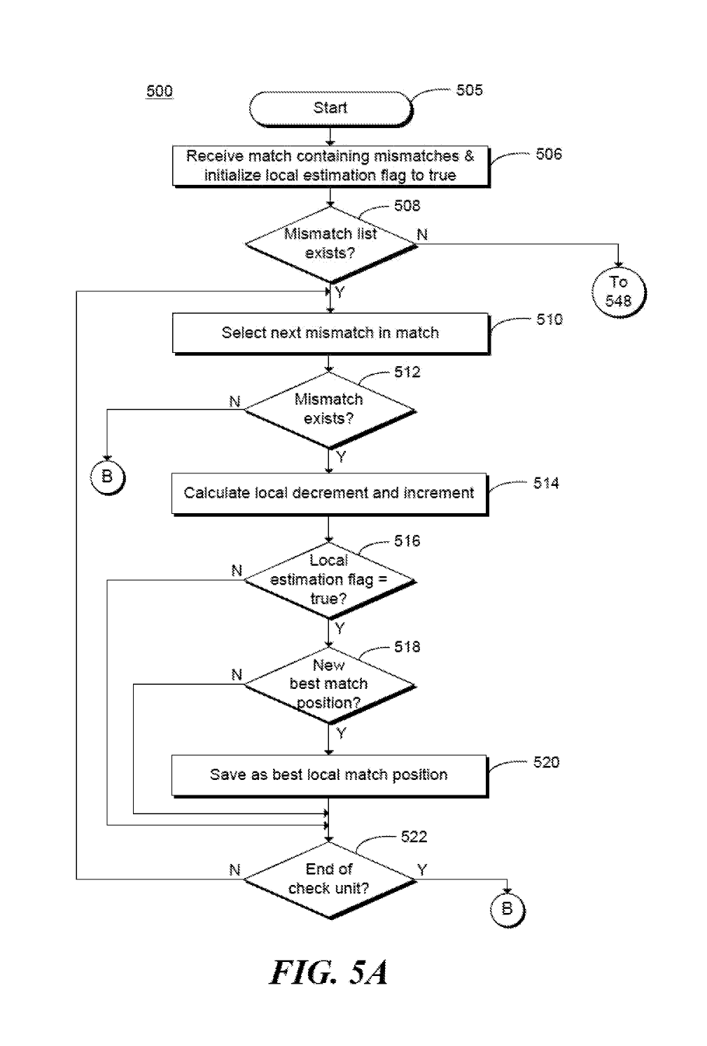

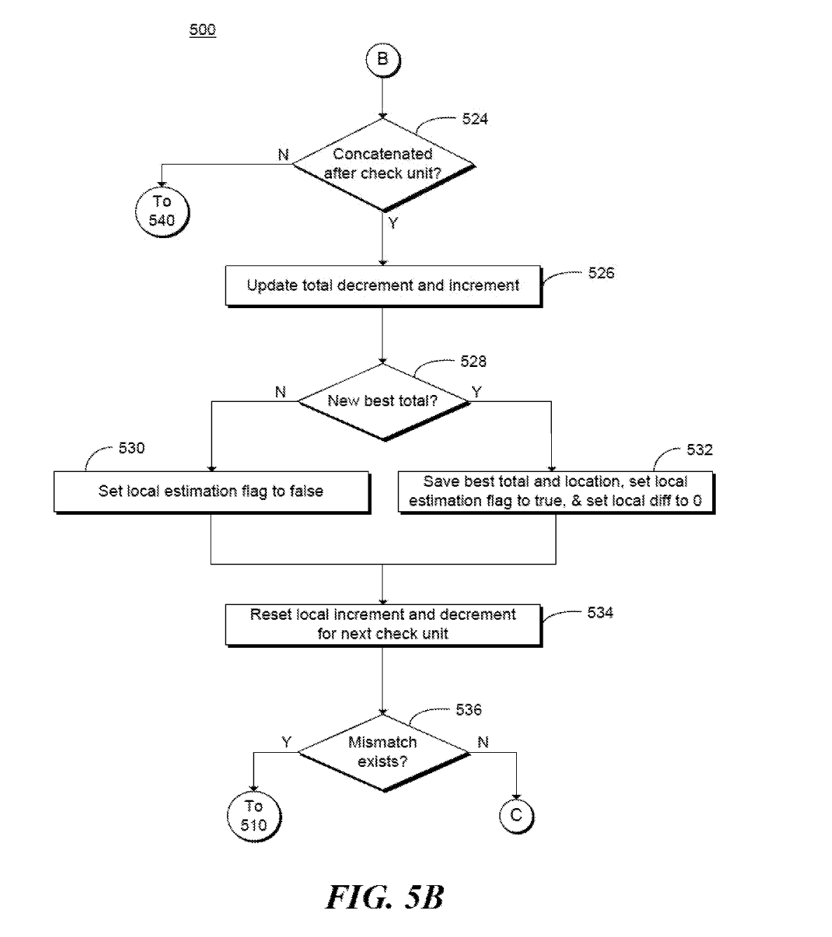

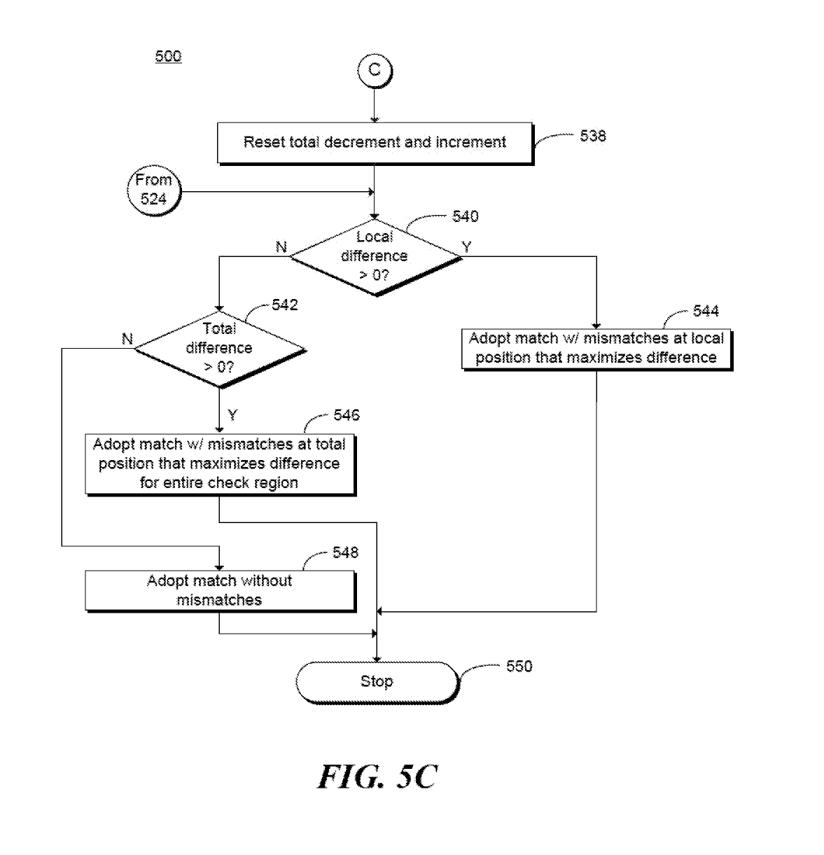

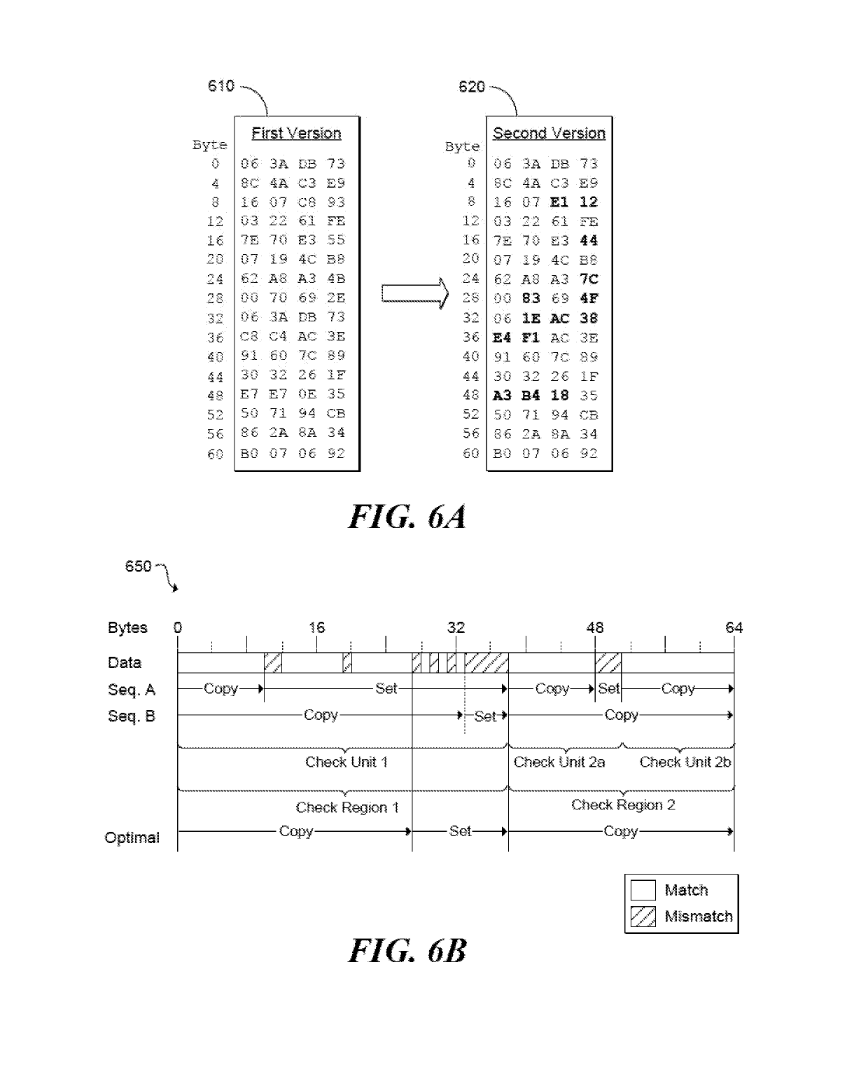

In some embodiments, optimization instructions 224 may analyze match candidates by abstracting the matches into check objects. In particular, optimization instructions 224 may use a “check region” as a high-level check object that includes the match candidate and the next set section (i.e., the next non-matching section) or the end of V2. Optimization instructions 224 may further divide each check region into a number of “check units,” which are defined with reference to the matching without mismatches technique. In particular, a check unit may be defined to include one copy region and zero or one set regions. When a check unit includes a set region, the unit ends at the boundary of the set region. Further details of a process for analyzing a particular match using a check region and one or more check units are provided below in connection with FIGS. 5A-5C, 6A, and 6B.

After execution of match optimization instructions 224 for a particular match candidate, best candidate selection instructions 226 may determine whether the match candidate is the best candidate determined so far. If so, best candidate selection instructions 226 may save the match candidate as the current best match. As an alternative, best candidate selection instructions 226 may execute after all candidate matches have been optimized to determine the lowest cost match of all candidates. Regardless of the method used, best candidate selection instructions 226 may save the lowest cost match. When there are additional blocks of V2 to be processed, execution may return to match candidate selection 222. Alternatively, execution may proceed to optimized update package encoding instructions 230 for generation of the update package.

After an optimal match is determined for each portion of V2, optimized update package encoding instructions 230 may encode an update package using the optimal matches. In particular, encoding instructions 230 may read each match, determine the commands to be encoded, and generate the machine-code instructions to be included in the update package for each command.

Update package transmitting instructions 240 may manage the process for transferring the update package to particular clients. In particular, after generation of the optimized update package, update package transmitting instructions 240 may prepare the update package for distribution to the client base. For example, the first version of the executable file may be software or firmware included in a set of client devices, which may include a particular client device 260. Thus, update package transmitting instructions 240 may notify client device 260 of the availability of an update package and, in response to a download request from client device 260, initiate a transfer of the update package from computing device 200 via network 250, which may be any packet-switched or circuit-switched network (e.g., the Internet).

Client device 260 may be any computing device suitable for execution of software and firmware. For example, client device 260 may be a desktop or laptop computer, a mobile phone, a portable reading device, or the like. Client device 260 may include software or firmware 264 to be updated and an update installer 262 for installing a received update package. Upon receipt of an update package, client device 260 may execute update installer 262 to process the update package and modify the previous version of the software/firmware 264 using the instructions contained therein.

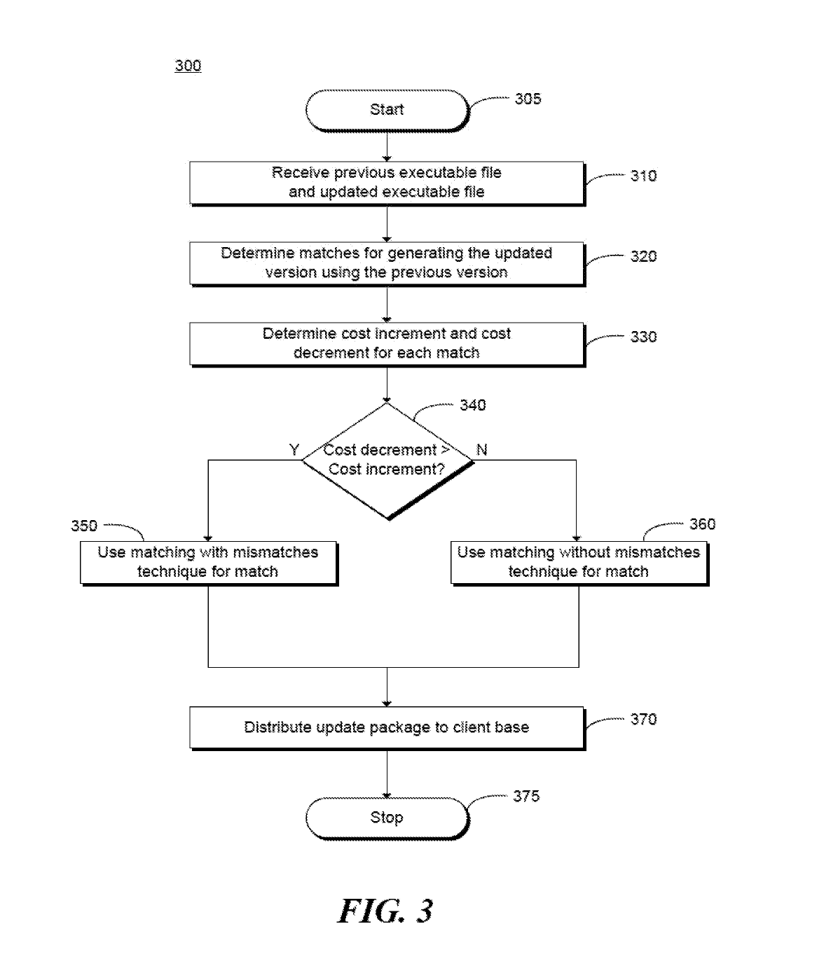

FIG. 3 is a flowchart of an example method 300 for analyzing matches to generate and distribute an optimized update package. Although execution of method 300 is described below with reference to the components of computing device 100, other suitable components for execution of method 300 will be apparent to those of skill in the art. Method 300 may be implemented in the form of executable instructions stored on a machine-readable storage medium, such as machine-readable storage medium 120 of computing device 100 or a machine-readable storage medium included in computing device 200.

Method 300 may start in block 305 and proceed to block 310, where computing device 100 may receive two executable files, including a previous version and an updated version. The previous version of the executable file may be, for example, an executable that is currently distributed to a client base, while the updated version may be a new version that has yet to be distributed.

After receipt of the two executable files, method 300 may proceed to block 320, where computing device 100 may determine matches for generating the updated version of the executable file using the previous version. In particular, each determined match may represent a set of commands used to generate a portion of the updated executable using an identified portion of the previous executable.

As detailed above, computing device 100 may determine the matches using a matching with mismatches technique, such that mismatches of up to a predetermined length are tolerated in the matching procedure. As a result, each of the matches may include a copy command and zero or more set pointer commands. Again, the copy command may define the boundary of each match, while the set pointer commands may specify the data to be used for particular non-matching blocks within the boundaries defined by the copy command.

After determining matches, method 300 may proceed to block 330, where computing device 100 may determine a cost increment and decrement for each match identified in block 320. In particular, for each set pointer command in a given match, computing device 100 may determine the decrement to be the number of adjacent blocks that are matching (i.e., the number of bytes for which duplication is avoided). When the matching procedure implements a set pointer cache, the decrement may also include the number of bytes for which encoding was avoided due to a hit in the cache. Similarly, computing device 100 may determine the increment to be the number of bytes required to encode the command and the <from> parameter for the particular set pointer command.

After determining each cost decrement and increment, method 300 may proceed to block 340, where computing device 100 may determine whether the cost decrement is greater than the cost increment for at least one position in each match. When it is determined that the decrement exceeds the increment for a particular match, computing device 100 may determine that the use of the matching with mismatches technique provides a cost benefit and therefore accept it for the match. Accordingly, method 300 may proceed to block 350, where computing device 100 may encode the update package using the matching with mismatches technique for the particular match. In particular, computing device 100 may use a combination of copy and set pointer commands to encode the match. In some embodiments, computing device 100 may only use set pointer commands up to a location at which the difference between the decrement and increment is maximized and use a single set command subsequent to that location.

Alternatively, when it is determined in block 340 that the cost decrement is less than or equal to the cost increment at all locations in the match, computing device 100 may determine that the use of matching without mismatches provides a better cost. Method 300 may therefore proceed to block 360, where computing device 100 may encode the update package using the matching without mismatches technique for the particular match. In particular, computing device 100 may encode the match using a copy command up to a first mismatch location and a set command subsequent to that location.

Blocks 340, 350, and 360 may be repeated as described above for each identified match, such that the optimal technique is determined for each match. Method 300 may then proceed to block 370, where computing device 100 or some other server may distribute the encoded update package to the client base. Method 300 may then proceed to block 375, where method 300 may stop.

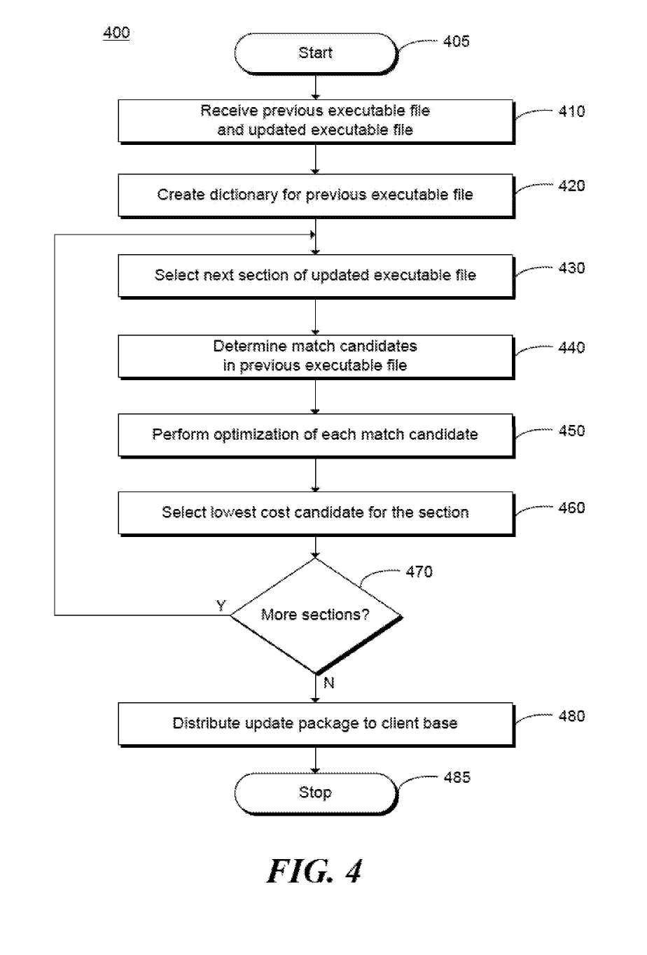

FIG. 4 is a flowchart of an example method 400 for processing a plurality of sections of an updated executable file to generate and distribute an optimized update package. Although execution of method 400 is described below with reference to the components of computing device 200, other suitable components for execution of method 400 will be apparent to those of skill in the art. Method 400 may be implemented in the form of executable instructions stored on a machine-readable storage medium, such as a machine-readable storage medium included in computing device 200 or machine-readable storage medium 120 of computing device 100.

Method 400 may start in block 405 and proceed to block 410, where computing device 200 may receive a previous executable file and an updated executable file for which an update package is desired. Method 400 may then proceed to block 420, where computing device 200 may create a dictionary for the previous executable file. In particular, computing device 200 may calculate a CRC for each of a plurality of blocks in the previous executable file. As described in detail below, this dictionary may be used in identifying blocks in the previous executable file that match sections of the updated executable file.

After generation of the dictionary, method 400 may proceed to block 430, where computing device 200 may select a next section of the updated executable file for match analysis. For example, computing device 200 may select a section of the updated executable file of the same length used for the CRC calculations of the previous executable file.

Method 400 may then proceed to block 440, where computing device 200 may identify a number of match candidates in the previous version of the executable file. For example, computing device 200 may calculate a CRC for the selected section, then begin searching through the dictionary for the previous executable file to identify a match. Once a match is identified, computing device 200 may continue to traverse the previous executable file after the matching point to identify a match of maximal length. As detailed above, in traversing the previous executable file to lengthen a match, computing device 200 may ignore mismatches up to a predefined mismatch length. Computing device 200 may then repeat this procedure to identify all match candidates in the previous executable file for the selected block in the updated version.

After identifying all candidates for the selected block in the updated version of the executable file, method 400 may proceed to block 450, where computing device 200 may perform optimization for each match candidate identified in block 440. An example method for performing the optimization of each match candidate is described in detail below in connection with FIGS. 5A-5C.

After obtaining an optimized match for each candidate, method 400 may proceed to block 460, where computing device 200 may calculate a cost for encoding each optimized match. The cost of encoding may be equal to the total cost of all commands to be encoded, including any parameters and data. Computing device 200 may then select the lowest cost candidate for the section and encode the commands for the identified candidate.

Method 400 may then proceed to block 470, where computing device 200 may determine whether there are additional sections of the updated executable file to be encoded. When it is determined that there are additional sections to be encoded, method 400 may return to block 430 for processing of the next section. Alternatively, when it is determined that all sections of the updated executable file have been analyzed and encoded, method 400 may proceed to block 480, where computing device 200 may distribute the update package to the client base. Finally, method 400 may proceed to block 485, where method 400 may stop.

FIGS. 5A, 5B, and 5C are flowcharts of an example method 500 for performing optimization of each match candidate for inclusion in an optimized update package. Although execution of method 500 is described below with reference to the components of computing device 200, other suitable components for execution of method 500 will be apparent to those of skill in the art. Method 500 may be implemented in the form of executable instructions stored on a machine-readable storage medium, such as a machine-readable storage medium included in computing device 200 or machine-readable storage medium 120 of computing device 100.

In the description of method 500 that follows, it should be noted that, for matches with a single check unit, computing device 200 may perform only a local cost estimation and, if a best cost position can be obtained, uses a copy command up to the best cost position and a set data command subsequent to that spot. For matches containing multiple check units, computing device 200 may perform local estimation for the first check unit and a total cost estimation at the boundary of every check unit. In some embodiments, a “lazy estimation” method may then be used, such that computing device 200 may perform local cost estimation for subsequent check units only when a good position is obtained during the total cost estimation procedure for the preceding check unit. In this manner, the best cost length may be located at a boundary of a check unit and, in some cases, may be lengthened to a local position in a subsequent check unit. Each of these cases is captured in the following description of method 500.

Method 500 may start in block 505 and proceed to block 506, where computing device 200 may provide a match including mismatches as input to the method. Each match may include, for example, information regarding the data matched in the previous executable file, such as a starting point of the matched data in the previous executable file, a length of the match, and a location of the data in the updated executable file. Each match may also include information regarding mismatches, including an offset of the mismatch and the mismatched data. In some embodiments, each match may be an object that includes data types that encode the information regarding the match and that includes a mismatch object. The mismatch object may be, for example, a linked list containing a series of mismatch objects. In some embodiments, each match may be a “check region,” which, as described below, may include one or more “check units,” which are defined with reference to the matching without mismatches technique.

In addition, in block 506, computing device 200 may also initialize the value of a local estimation flag to true. The local estimation flag may be, for example, a Boolean value, a string, an integer, or any other data type capable of denoting two states (i.e., true and false). As described in detail below, the local estimation flag may be used to allow for selective execution of the local estimation procedure for each check unit. In other words, the local estimation flag may be used to assist in determining when to apply the lazy estimation procedure.

After receipt of a particular match and initialization of the local estimation flag, method 500 may proceed to block 508, where computing device 200 may determine whether a mismatch list exists in the match object. When it is determined that such a mismatch list does not exist, computing device 200 may determine that the match contains no set pointer commands. Thus, method 500 may proceed to block 548 of FIG. 5C, where the matching without mismatches may be applied. Alternatively, when the mismatch list exists in the match object, method 500 may proceed to block 510.

In block 510, computing device 200 may select the next mismatch included in the match data. As an example, when the mismatch object is a linked list, computing device 200 may select the head of the list in the first iteration. Similarly, when the mismatch object is an array, computing device 200 may select the mismatch object contained in index 0 in the first iteration. Other suitable methods of selecting a mismatch will be apparent to those of skill in the art based on the particular encoding method used.

After selecting the next mismatch, method 500 may proceed to block 512, where computing device 200 may determine whether the particular mismatch exists. To use the linked list example, computing device 200 may determine whether the current value of the pointer is not equal to “NULL.” When the mismatch does not exist, computing device 200 may determine that it has reached the end of the mismatch list (and, therefore, the end of the check region) and method 500 may proceed to block 524 of FIG. 5B. Alternatively, when the mismatch exists, method 500 proceeds to block 514.

In block 514, computing device 200 may determine the local decrement and increment for the current check unit. In some embodiments, each of these values may represent a running total within the check unit, such that the current decrement and increment are added to the previous totals. Computing device 200 may first determine the local decrement, which may include a number of matching bytes subsequent to the current mismatch, but prior to the next mismatch, if any. Thus, the decrement may represent the number of bytes copied from the previous executable file that would have been included in a corresponding set command if the matching without mismatches technique were used. When a set pointer cache is used, the decrement may also include the number of mismatched bytes when the mismatched data is already contained in the set pointer cache (i.e., when there is a cache hit).

Computing device 200 may then determine the local increment, which may include the number of bytes required to encode the set pointer command plus the number of bytes required to encode the <from> parameter. It should be noted that, in determining the local increment for a given check unit, computing device 200 may exclude one set pointer command and its associated costs, as those costs are also incurred when using a set data command. Thus, in a check unit with only one set pointer command, the local cost increment is zero, as there are no additional bytes as compared to the matching without mismatches technique. In contrast, in a check unit with n set pointer commands, where n is greater than or equal to 2, the local increment may include the cost imposed by each of the n−1 additional set pointer commands.

After determining the new running total for the local decrement and increment, method 500 may proceed to block 516, where computing device 200 may determine whether the local estimation flag is set to true. If so, computing device 200 may determine that it should keep track of the best position within the check unit and, as a result, method 500 may proceed to block 518. It should be noted that, because the local estimation flag is set to true in block 506, local estimation will always be performed for the first check unit in a match. Alternatively, when the local estimation flag is set to false, computing device 200 may determine that it is only tracking the best position at the end of check units and, therefore, skip to block 522.

In block 518, computing device 200 may determine whether the local decrement minus the local increment is greater than the difference for a previous best match position (or greater than 0 for the first iteration). When it is determined that the difference is a new best, method 500 may proceed to block 520, where computing device 200 may save the position of the mismatch as the new best local match position. Method 500 may then proceed to block 522. Alternatively, when it is determined in block 518 that the difference is not a new best, method 500 may skip directly to block 522.

In block 522, computing device 200 may determine whether it has reached the end of a particular check unit. For example, computing device 200 may determine whether the matching portion that follows the current mismatch has a length greater than or equal to the minimum match size required for a copy command (e.g., 8 bytes or more). If so, computing device 200 may determine that the next command is a copy command and that is has therefore reached the boundary of the check unit. Method 500 may therefore proceed to block 524 of FIG. 5B for processing performed at the end of a check unit. Alternatively, when it is not the end of a check unit, method 500 may return to block 510 for selection and processing of the next mismatch included in the current check unit.

Referring now to FIG. 5B, after it is determined that the end of the match (i.e., check region) or the end of a check unit has been reached, method 500 may proceed to block 524. In block 524, computing device 200 may determine whether the previous check unit is concatenated with a next check unit. In other words, computing device 200 may determine whether the previous check unit and a next check unit are part of a single copy region. If so, method 500 may proceed to block 526. Alternatively, when it is determined that the previous check unit is not concatenated with a next check unit (e.g., when there is only a single check unit in the match), method 500 may proceed to block 540 of FIG. 5C.

In block 526, computing device 500 may update the total decrement and increment for the check region by adding the cumulative local decrement and increment, respectively. The total decrement and increment may be used to track the optimal position at the boundaries of check units. In some embodiments, when a lazy estimation procedure is applied to the total cost estimation, the total decrement also includes savings of an associated COPY command.

Method 500 may then proceed to block 528, where computing device 200 may determine whether the total decrement minus the total increment is greater than or equal to the previous best total (or 0 for the first iteration). If not, computing device 200 may determine that local estimation should not be performed for subsequent check units until a new best total is encountered. Method 500 may therefore proceed to block 530, where computing device 200 may set the local estimation flag to false, such that only the total difference is check until the total difference at a given check unit boundary is a new best. After setting the local estimation flag to false, method 500 may proceed to block 534, described in detail below.

Alternatively, when it is determined that the total decrement minus the total increment is greater than the previous best total, method 500 may proceed to block 532, where computing device 200 may save the best total and the location in the match at which this total is obtained. In addition, computing device 200 may set the local estimation flag to true, such that local estimation is performed for the next check unit. In this manner, computing device 200 may later perform local processing for the next check unit to determine if the length of the match can be increased to a position within the next check unit. Finally, computing device 200 may reset the local difference value to zero in preparation for processing of the next check unit. This will ensure that the best total position will be used if a new local match is not obtained before method 500 reaches FIG. 5C. Method 500 may then proceed to block 534.

After execution of either block 530 or block 532, method 500 may proceed to block 534. In block 534, computing device 200 may reset the values of the local increment and decrement in preparation for processing of the next check unit, if such processing will be performed (this depends on the value of the local estimation flag).

Method 500 may then proceed to block 536, where computing device 200 may determine whether the current mismatch exists (e.g., whether the current value of the pointer is not equal to NULL). This determination is equivalent to the determination of whether computing device 200 has reached a mismatch in the next check unit (the mismatch exists) or has reached the end of the match (a mismatch does not exist). When it is determined that the current mismatch exists (i.e., that this is a new mismatch in the next check unit), method 500 may return to block 510 of FIG. 5A for processing of the next check unit. Alternatively, when it is determined that the current mismatch does not exist (i.e., that it has reached the end of the match), method 500 may proceed to block 538 of FIG. 5C for end of match processing.

Referring now to FIG. 5C, in block 538, computing device 200 may reset the total increment and decrement in preparation for processing of the next check region in a next iteration of the method. Method 500 may then proceed to block 540, where computing device 200 may determine whether the best local difference is greater than zero. If so, method 500 may proceed to block 544, where computing device 200 may adopt the matching with mismatches technique for the check region up to the point at which the best local difference existed. Accordingly, computing device 200 may apply the matching with mismatches technique up to this position within a particular check unit and generate a SET DATA command for the remaining portion of the particular check unit. In this manner, the generated COPY command may include zero or more full check units and a portion of one check unit, with SET PTR commands included to encode any mismatches. If there are remaining check units in the match following the selected position, the match and estimation procedure may be performed for those check units in a subsequent iteration. Method 500 may then proceed to block 550, where method 500 may stop.

Alternatively, if it is determined in block 540 that the local difference is less than or equal to zero, method 500 may proceed to block 542. In block 542, computing device 200 may determine whether the best total difference for any of the check units is greater than zero. In other words, computing device 200 may determine whether the best position occurs at the boundary of one of the check units. When it is determined that the best total difference is greater than zero for a given check unit, method 500 may proceed to block 546.

In block 546, computing device 200 may adopt the match with mismatches technique up to the total position that maximizes the difference for the entire check region. In other words, computing device 200 may select the position at the end of one of the processed check units at which the total difference is maximized. Accordingly, computing device 200 may apply the matching with mismatches technique up to this position and, if there are remaining check units in the match, perform the match and estimation procedure for those check units in a subsequent iteration. Method 500 may then proceed to block 550, where method 500 may stop.

Alternatively, when it is determined in block 542 that the best total difference for all check units is less than or equal to zero, method 500 may proceed to block 548. In block 548, computing device 200 may adopt the matching without mismatching technique for the first check unit. Thus, computing device 200 may use a copy command up to the position of the first mismatch in the first check unit, while using a single set command after that position. In addition, if there are additional check units in the match, the match and estimation procedure may be performed for these check units in a subsequent iteration. Method 500 may then proceed to block 550, where method 500 may stop.

In the preceding description of method 500, local estimation is performed for a particular check unit (other than the first check unit) only when the total estimation for the previous check unit yielded a good result. Thus, as described above, set data and copy commands are exclusive, such that a copy command is broken into multiple commands prior to insertion of a set data command.

In an alternative embodiment, this issue may be addressed by only using a local cost estimation procedure for each check unit in a match that includes multiple check units (i.e., no total cost estimation is performed). This procedure may be implemented as a method executed by a computing device or, alternatively, as a series of executable instructions encoded on a machine-readable storage medium. To implement such a procedure, the entire match would first be adopted as a single copy command. Then, the local cost estimation procedure would be performed for each check unit.

In executing the local estimation procedure for a particular check unit, when a best local position can be obtained, the matching with mismatches may be adopted up to the best local position. Thus, up to this position, the check unit may contain a copy command (if it is the first check unit) and one or more set pointer commands. Subsequent to the best local position, the matching without mismatches may be adopted using an additional command. In particular, an INNER SET DATA command may be utilized to encode all bytes after the best position, which may include one or more non-matching bytes and one or more matching bytes. In this manner, the copy command for the entire match may be preserved, while allowing for the use of the matching without mismatches technique within a given check unit.

In contrast, when a best local position cannot be obtained using the local estimation procedure for a particular check unit, the matching without mismatches may be adopted using the inner set data command. In particular, the check unit may be encoded using the inner set data command starting at the position of the first mismatch in the check unit, such that the entire mismatches portion of the check unit is encoded using the inner set data command. In this manner, a cost savings may be introduced by using the inner set data command to avoid a break in the outer copy command for the entire match and therefore eliminating the need for an additional copy command.

FIG. 6A is a block diagram of an example of a previous executable file 610 and an updated executable file 620. As illustrated, each example executable file includes a total of 64 bytes, as each pair of hexadecimal numerals is a single byte. The examples that follow assume that each byte is numbered from 0 to 63, with the numbering starting from the first byte in the top row. As illustrated by the boldface type, bytes 10, 11, 19, 27, 29, 31, 33-37, and 48-50 have changed from the previous executable file to the updated executable file.

FIG. 6B is a block diagram of an example 650 of a matching without mismatches, a matching with mismatches, and an optimized matching for generation of an optimized update package for the executable files of FIG. 6A. The row labeled “Data” in FIG. 6B illustrates the bytes contained in the second version 620 as compared to the bytes in the first version 610. In particular, a non-shaded area indicates that the bytes at a particular position in the second version 620 match the bytes at the same position in the first version 610. Conversely, a shaded area indicates that the bytes at a particular position in the second version 620 do not match the bytes at the same position in the first version 610.

Sequence A illustrates an example of the application of a matching without mismatches technique as applied to the second version 620, assuming a copy discriminator length of eight bytes. In particular, to determine a matching without mismatches, a computing device 100, 200 may look for a matching portion of at least eight bytes in the first version 610 starting with the first eight bytes of the second version (“06 3A DB 73 8C 4A C3 E9”). As illustrated, the first ten bytes of the files match, so a first command included in sequence A is a copy command that references the first ten bytes of the first version 610.

The computing device 100, 200 would then continue traversing the second version 620 to find blocks of at least eight bytes that contain a corresponding match in the first version 610. As illustrated, another match is not present in the first version 610 until reaching byte 38 (“AC”). Accordingly, an additional copy command would be added starting with byte 38 and ending with byte 47. Continuing this process would result in one additional copy command that starts at byte 51 and ends at byte 63.

In order to fill the gaps between the copy commands, the computing device 100, 200 would create two set commands. In particular, a first set command would contain the data of bytes 10 through 37, while a second set command would contain the data of bytes 48 through 50.

Sequence B illustrates an example of the application of the matching with mismatches technique as applied to the second version 620, assuming a mismatch length of four bytes. As illustrated, in determining a first copy command, the computing device 100, 200 would not encounter a mismatch of greater than four bytes until reaching bytes 33 to 37 of the first version 610. Accordingly, the first 33 bytes of the second version 620 would be encoded using a single copy command in combination with five set pointer commands. Bytes 33 to 37 would be encoded using a set command with five bytes of data, while the remainder of the second version 620 would be encoded using one copy command in combination with one set pointer command.

As illustrated beneath Sequences A and B, the mapping may be divided into check regions and check units for analysis using the method described above in connection with FIGS. 5A-5C. In particular, Check Region 1 is defined by the first match, which includes the copy command for bytes 0 to 32, five set pointer commands, and the set command for bytes 33 to 37. Check Region 1 includes Check Unit 1, which corresponds to the entire check region. As detailed above, a check unit may be defined with respect to the matching without mismatches to contain a copy command and zero or one set commands. Accordingly, Check Unit 1 includes bytes 0 through 37.

Similarly, Check Region 2 is defined by the second match, which includes the copy command for bytes 38 to 64 and a single set pointer command. Check Region 2 includes Check Unit 2a, which corresponds to the copy and set combination from bytes 38 through 50 of the matching without mismatches. Check Region 2 also includes Check Unit 2b, which corresponds to the remaining copy command in the matching without mismatches.

Finally, FIG. 6B illustrates an optimal matching as determined by the application of method 500 to Check Regions 1 and 2. In particular, for Check Region 1, method 500 would traverse Check Unit 1, starting with the mismatch at byte 10. Method 500 would determine, at each mismatch position, a cumulative local decrement, a cumulative local increment, and a difference between the two. Here, because there is only a single check unit, method 500 would not perform the total estimation. Accordingly, method 500 would select the position at which the local difference is maximized, which, in this case, would be the position of the second mismatch.

Method 500 would therefore truncate the match starting with the third mismatch, applying the matching with mismatches technique prior to this position and generating a SET DATA command subsequent to this position. Accordingly, for the first 37 bytes of the second version 620, the optimized update package would include a copy command in combination with two set pointer commands up to byte 28 and a single set command from bytes 29 through 37.

Processing of Check Region 2 would proceed in a similar manner. In particular, method 500 would determine that the optimal match would be obtained by maintaining the entire copy command for the check region. Accordingly, for bytes 38 to 64 of the second version 620, the update package would include a copy command in combination with a single set pointer command that encodes bytes 48 to 50.

According to the foregoing, various embodiments relate to generation of an update package of a minimized size through match analysis. In particular, various embodiments described above analyze matches generated for an update package to select matches that result in an update package of a minimized size. In this manner, the instructions used to generate an updated executable file using a previous version of the executable file may be optimized. Accordingly, software or firmware maintained on a client device may be updated by transmitting the update package to the client and applying the update package to the current executable maintained on the client device in a manner that minimizes transmission length, bandwidth usage, and installation time.

I claim:

1. A machine-readable storage medium encoded with instructions executable by a processor of a computing device, the machine-readable storage medium comprising:
instructions for receiving an updated executable file and a previous executable file;
instructions for determining a plurality of matches, each match representing a set of commands used to generate a portion of the updated executable file using the previous executable file;
instructions for comparing a matching with mismatches technique with a matching without mismatches technique for each of the plurality of matches;
instructions for selecting an optimal technique that provides a minimal cost for each respective match of the plurality of matches, wherein the optimal technique is either the matching with mismatches technique or the matching without mismatches technique;
instructions for encoding an optimized update package, the optimized update package applying the optimal technique selected for each respective match.

2. The machine-readable storage medium of claim 1, wherein each command represented by a particular match is selected from the group consisting of a copy command and a set pointer command.

3. The machine-readable storage medium of claim 2, wherein:
the instructions for selecting the optimal technique determine an optimal location in the particular match that provides a minimal cost when utilizing the matching with mismatches technique, and
the instructions for encoding the optimized update package utilize the copy command in combination with zero or more set pointer commands up to the optimal location in the particular match and utilize a set command after the optimal location.

4. The machine-readable storage medium of claim 2, wherein:
when the optimal technique for the particular match is the matching without mismatches technique, the instructions for outputting the optimized update package utilize only a copy command for the particular match.

5. The machine-readable storage medium of claim 1, wherein:
each match includes at least one check unit, and
the boundaries of each check unit correspond to command boundaries created by the matching without mismatches technique.

6. The machine-readable storage medium of claim 5, wherein:
the instructions for comparing the techniques comprise instructions for determining, for each of the plurality of matches:
a local cost decrement and a local cost increment obtained at each of a plurality of locations in selected check units of the match by using the matching with mismatches technique, and
a total cost decrement and a total cost increment obtained at a boundary of each check unit in the match by using the matching with mismatches technique.

7. The machine-readable storage medium of claim 6, wherein:
when the total cost decrement exceeds the total cost increment for at least one check unit, the optimized update package uses the matching with mismatches technique up to a check unit boundary at which the difference between the total cost decrement and the total cost increment is maximized, and
when the local cost decrement exceeds the local cost increment for at least one location, the optimized update package uses the matching with mismatches technique at least up to a location at which the difference between the local cost decrement and the local cost increment is maximized.

8. The machine-readable storage medium of claim 5, wherein:
the instructions for comparing the techniques comprise instructions for determining a position at which a greatest local cost savings is obtained in each respective check unit by using the matching with mismatches technique, if such a position exists,
the optimized update package uses a single copy command for the entire match,
when there is a position at which a greatest local savings is obtained for the respective check unit, the optimized update package uses the matching with mismatches technique up to the position and uses an inner set data command subsequent to the position in the respective check unit,
when there is no position at which a greatest local cost savings is obtained for the respective check unit, the optimized update package uses the inner set data command for encoding an entire mismatches portion of the check unit.

9. A computing device comprising:
a processor; and
a machine-readable storage medium encoded with instructions executable by the processor, the machine-readable storage medium comprising:
instructions for receiving an updated executable file and a previous executable file,
instructions for determining a plurality of matches, each match representing a set of commands used to generate a portion of the updated executable file using the previous executable file, wherein each match represents a combination of copy and set pointer commands,
instructions for analyzing each match to determine an optimal number of set pointer commands that minimizes a cost of encoding the match, wherein the optimal number of set pointer commands is between zero and a number of set pointer commands included in the match, and
instructions for encoding an optimized update package, the optimized update package including the optimal number of set pointer commands in each match.

10. The computing device of claim 9, wherein the instructions for analyzing determine the optimal number of set pointer commands for a particular match by determining a position of a set pointer command at which the difference between a cost decrement gained by using the set pointer command and a cost increment imposed by using the set pointer command is maximized.

11. The computing device of claim 10, wherein, for a first check unit of the match that contains a combination of copy and set pointer commands:
when the difference between a total cost decrement and a total cost increment for the entire first check unit of the match is non-negative, the instructions for analyzing select the entire first check unit of the match including all set pointer commands, and
when the difference between the total cost decrement and the total cost increment for the entire first check unit of the match is negative, the instructions for analyzing select the match up to a local position of the set pointer command at which the difference is maximized, if such a local position exists.

12. A method for minimizing a size of an update package, the method comprising:
determining a plurality of matches between an updated executable file and a previous executable file, each match representing a set of commands used to generate a portion of the updated executable file using the previous executable file, wherein the set of commands includes a copy command and zero or more set pointer commands;
analyzing each match to determine a cost increment imposed by each set pointer commands in the match and a cost decrement obtained by avoiding duplication of bytes contained in the previous executable file;
comparing the cost increment and the cost decrement for each match to determine whether to use the matching with mismatches technique or a matching without mismatches technique for the match; and
encoding an optimized update package, the optimized update package using the determined technique for each match.

13. The method of claim 12, wherein comparing the cost increment and the cost decrement for each match comprises:
determining a difference between the cost decrement and the cost increment at each set pointer command location in the match,
when there is at least one location at which the difference is non-negative, using the matching with mismatches technique up to a location at which the difference is maximized and using a set section after the location, and
when the difference is negative at all locations in the match, using the matching without mismatches technique for the entire match.

14. The method of claim 13, wherein comparing the cost increment and the cost decrement for each match further comprises:
determining a difference between a total cost decrement for the match and a total cost increment for the match, and
when the difference between the total cost decrement and the total cost increment is non-negative at a particular location, using the matching with mismatches technique up to the particular location.

15. The method of claim 12, wherein:
for each set pointer command, the cast increment is equal to a numb of bytes required to encode the set pointer command plus a number of bytes required to encode a location of a mismatch, and
for each set pointer command, the cost decrement is equal to a number of bytes copied from the previous executable it that would be included in corresponding set commands in the matching without mismatches technique.
